(19) United States
(12) Patent Application Publication
(10) Pub. No.: US 2024/0251432 A1
(43) Pub. Date: Jul. 25, 2024

(54) METHOD FOR COMMUNICATION BETWEEN A BASE STATION AND AT LEAST ONE ITEM OF COMMUNICATION EQUIPMENT, BASE STATION, COMMUNICATION EQUIPMENT AND COMPUTER PROGRAM CORRESPONDING THERETO

(71) Applicant: Orange, Issy-Les-Moulineaux (FR)

(72) Inventors: Régis FRECHIN, Chatillon Cedex (FR); Pierre DUBOIS, Chatillon Cedex (FR)

(21) Appl. No.: 18/575,796

(22) PCT Filed: Jun. 29, 2022
(86) PCT No.: PCT/FR2022/051296

§ 371 Date: Dec. 29, 2023

(30) Foreign Application Priority Data
Jul. 1, 2021 (FR) FR2107154

(51) Int. Cl. H04W 72/542

(52) U.S. Cl. CPC H04W 72/542

(57) ABSTRACT

A method for communication between a base station and at least one item of communication equipment attached to the base station. The method includes: obtaining at least one first value of a quality of a radio uplink or downlink between the base station and one of the items of equipment, referred to as client equipment, allocating radio resources to the item of equipment in accordance with an allocation scheme implementing a first radio quality of service configuration, if at least one current value of a quality of the radio uplink or downlink between the base station and the item of client equipment is associated with a radio link quality level lower than the at least one first uplink or downlink value, respectively, allocating radio resources to the item of equipment attached to the base station in accordance with an allocation scheme implementing a second radio quality of service configuration.

### CROSS-REFERENCE TO RELATED APPLICATIONS

This application is filed under 35 U.S.C. § 371 as the U.S. National Phase of Application No. PCT/FR2022/051296 entitled “METHOD FOR COMMUNICATION BETWEEN A BASE STATION AND AT LEAST ONE ITEM OF COMMUNICATION EQUIPMENT, BASE STATION, COMMUNICATION EQUIPMENT AND COMPUTER PROGRAM CORRESPONDING THERETO” and filed Jun. 29, 2022, and which claims priority to FR 2107154 filed Jul. 1, 2021, each of which is incorporated by reference in its entirety.

### BACKGROUND

### Field

The field of the invention is that of telecommunications.

More precisely, the invention relates to uplink communications, that is from the communication equipment to a base station, and downlink communications, that is from the base station to the communication equipment.

A communication equipment refers here to a terminal equipment of the network (also referred to as UE for “User Equipment”), or an intermediate equipment of the network, such as a CPE (“Customer Premises Equipment”). Such a communication equipment can therefore be mobile or fixed.

The proposed solution applies in particular, but not exclusively, in the context of LTE/4G (“Long Term Evolution”) or 5G NR (“New Radio”) mobile networks.

### Prior Art

Typically, three main quality of service (QOS) configurations are distinguished based on the access to the radio spectral resources between the items of communication equipment:
configuration associated with a conventional allocation of radio resources, referred to as BE or “best effort”. The conventional allocation corresponds to a radio QoS configuration having a radio quality level that can be low if the cell load is high. According to this configuration, nothing in particular is put in place for a given equipment. The base station applies a scheduling algorithm that distributes the resources to the various items of equipment in the cell it serves, according to fairness rules. Such algorithms are, for example, of the “Round Robin” or “Proportional fair” type;
configuration associated with allocation of radio resources with relative prioritisation. The allocation with relative prioritisation corresponds to a radio QoS configuration having an intermediate radio quality level if the cell load is high. According to this configuration, the base station authorises more resources for streams of an equipment with relative prioritisation (with “privileged QoS”) than for those with “best effort”;
configuration associated with an allocation of radio resources with strict prioritisation at a guaranteed bit rate referred to as “GBR”. The allocation with GBR strict prioritisation corresponds to a radio QoS configuration having a high radio quality level even if the cell load is high. The base station ensures a minimum uplink and/or downlink bit rate for one or more streams of the equipment. The prioritisation between the BE streams and the GBR streams is therefore strict. It should be noted that if the cell's total resources allow it, the observed bit rates of the equipment at guaranteed bit rates can be higher than these minimum bit rates.

These three configurations, with different QoS levels, can coexist at the same time on different streams of the same equipment.

Hereafter, a stream transmitted or received by a communication equipment with a radio quality of service configuration associated with a “BE” allocation (respectively with relative prioritisation, respectively with strict prioritisation at a guaranteed bit rate) is referred to as a BE stream (respectively a stream “with privileged QoS”, respectively a “GBR” stream).

Typically, the mobile network (in particular the base station) is configured to provide a guaranteed target bit rate to the streams of the equipment benefiting from a GBR configuration as a priority. The remaining radio resources are then allocated, unless there is a specific configuration such as a bit rate restriction, to all the equipment, including the equipment with at least one “GBR” stream.

The GBR bit rates correspond to the bit rates that are necessary, useful, to provide the corresponding service. It can be for example the bandwidth required to transmit HD, 3D video streams, etc. There are, however, some disadvantages to setting up a configuration associated with an allocation with strict prioritisation at a guaranteed bit rate for some items of equipment, in particular mobile terminals.

Indeed, when a terminal receiving or transmitting at least one GBR stream is far from the base station, for example located at the edge of the cell, or the transmission channel between the base station and the terminal has a lot of interference, the amount of resources allocated to this terminal to offer it a guaranteed bit rate is very high, and is at the expense of the other terminals of the cell receiving or transmitting at least one “non-GBR” stream (for example terminals receiving or transmitting at least one BE stream or one stream with relative prioritisation). In other words, a terminal receiving or transmitting at least one GBR stream can drastically reduce the capacity of the cell and thus deteriorate the performance of the other terminals.

In addition, the aggregation of terminals receiving or transmitting at least one GBR stream in the same cell can lead to a shortage of resources for the terminals receiving or transmitting at least one “non-GBR” stream. In extreme conditions of cellular overload, the resources may even become insufficient to honour the sum of the GBR bit rates of the terminals in the cell.

Four typical states of a radio cell served by a base station can thus be defined:
cell with “no congestion”: there are more radio resources than necessary to handle the traffic of the communication equipment in the cell. The bit rates expected on the GBR streams are met, or even exceeded, the traffic of the BE streams flows without encountering any radio limitations;
controlled overall congestion in the cell: the equipment generates traffic that uses all the radio resources of the cell. The volume of radio resources required to serve the GBR stream is lower than the capacity of the cell, and corresponds to the operator's planning. The QoS mechanisms will make it possible to serve the “GBR” streams. The BE streams share the remaining radio resources, as defined by the operator;
uncontrolled overall congestion in the cell: the equipment generates traffic that uses all the radio resources of the cell. The volume of radio resources required to serve the GBR stream is lower than the capacity of the cell, but exceeds the operator's planning. The QoS mechanisms will make it possible to serve the “GBR” streams. The BE streams share the uncontrolled volume of remaining radio resources, which can drastically reduce and negatively impact the quality of experience of the users of the equipment transmitting or receiving these BE streams;
uncontrolled GBR congestion in the cell: all the communication equipment generates traffic that uses all the radio resources of the cell. In this case, the theoretical volume of radio resources required to serve the GBR stream exceeds the capacity of the cell, there is a shortage. The QoS mechanisms will no longer allow all the GBR streams to be served as intended. The network can then trigger protection mechanisms. However, despite the introduction of protection mechanisms, the quality of experience of the users of equipment receiving or transmitting “non-GBR” streams is extremely deteriorated. Moreover, the guaranteed target bit rates GBR cannot all be met, and the customer service (for example, HD, 3D video, etc.) may be disrupted.

To avoid the uncontrolled GBR congestion situation in the cell, an operator can set up mechanisms to limit the volume of radio resources that can be used for the GBR configurations (“slice” for example). When the theoretical volume of radio resources required to serve the GBR streams reaches this authorised “GBR” resource threshold, there is a shortage. One interest of these mechanisms is that the BE streams can be served by the radio resources preserved thanks to this mechanism.

In the last two cases of uncontrolled congestion, the proposed solutions do not maintain the quality of service equitably for all the equipment in a cell served by a base station.

There is therefore a need for a new technique for allocating radio resources to communication equipment attached to a base station.

### SUMMARY

The invention proposes a solution that does not have all the disadvantages of the prior art, in the form of a method for communication between a base station and at least one communication equipment attached to the base station, said at least one communication equipment comprising a client equipment.

According to the invention, such a method comprises:
obtaining at least one first value of a quality of a radio uplink or downlink between the base station and the client equipment,
allocating radio resources to said at least one equipment attached to the base station (i.e. to the client equipment attached to the base station and, where appropriate, to at least one other equipment attached to the base station) in accordance with an allocation scheme implementing a first radio QoS configuration dependent on said at least one first uplink or downlink value for at least one stream transmitted or received by the client equipment,
if at least one current value of a quality of the radio uplink or downlink between the base station and the client equipment, obtained from at least one measurement taken by the client equipment or the base station, is associated with a radio link quality level lower than said at least one first uplink or downlink value respectively, allocating radio resources to said at least one equipment attached to the base station in accordance with an allocation scheme implementing a second radio QoS configuration for at least one stream transmitted or received by the client equipment, said second configuration having a radio quality of service level lower than said first configuration.

Thus, according to the invention, for example during a first phase, a first value of a quality of the radio uplink between the base station and the client equipment and/or a first value of a quality of the radio downlink between the base station and the client equipment is/are obtained. This first value of a quality of the radio uplink and/or downlink can be associated with the first QoS configuration.

The base station can thus allocate radio resources to the client equipment and possibly to the other equipment it serves in accordance with an allocation scheme implementing this first radio QoS configuration (for example, allocation with strict prioritisation at a guaranteed bit rate), for at least one stream transmitted or received by the client equipment.

If the quality of the radio uplink and/or downlink between the base station and the client equipment deteriorates, the base station can change the allocation scheme to allocate radio resources by implementing a second radio QoS configuration for at least one stream transmitted or received by the client equipment (for example, allocation with relative prioritisation or “best effort” allocation), for example during a second phase implementing at least one iteration.

In this way, the maintenance of the QoS rules applied to at least one stream of the client equipment is conditioned by the observed quality of the radio link between the base station and the client equipment. If the radio link quality deteriorates (uplink, downlink or both, depending on the embodiment), the base station replaces for example the initial configuration of the QoS mechanisms (first radio QoS configuration) with a configuration that is less favourable to the client equipment (second radio QoS configuration).

In other words, the proposed solution activates QoS differentiation mechanisms for a client equipment by controlling the quantity of radio resources consumed by this access.

For example, if the radio link is of good quality (as during the first phase), the amount of radio resources to maintain a guaranteed bit rate is reasonable, and the base station can activate a first configuration associated with an allocation with strict prioritisation at a guaranteed bit rate for at least one stream of the client equipment. However, if the radio link is of lower quality, the amount of radio resources to maintain a guaranteed bit rate is very high, and the base station can activate a second configuration associated with an allocation with relative prioritisation or a BE allocation for at least one stream of the client equipment. It should be noted there are multiple reasons for the deterioration: deterioration of the client equipment antenna, of its support, appearance of an obstacle (construction of a wall, building, tree growth, etc.), weather conditions, etc.

It is thus possible to help control the disruptions caused to the other equipment attached to the base station with respect to a schedule set by the operator (initially, for example). For example, the first and second radio quality of service configurations belong to the group comprising:
a configuration associated with a conventional “best effort” allocation of radio resources (for the second configuration only);
a configuration associated with an allocation of radio resources with relative prioritisation;
a configuration associated with an allocation of radio resources with strict prioritisation at a guaranteed bit rate.

In all cases, the second radio QoS configuration has a lower quality level than the first configuration. For example, the first configuration is a configuration associated with an allocation with strict prioritisation at a guaranteed bit rate, and the second configuration is a configuration associated with an allocation with relative prioritisation or a BE allocation.

According to a particular embodiment, the method implements, prior to allocating radio resources in accordance with an allocation scheme implementing a second radio quality of service configuration, receiving said at least one downlink current value, from the client equipment.

The client equipment can therefore take one or more quality measurements of the radio downlink, at different times, to obtain one or more values of a quality of the radio downlink, and send the current value(s) to the base station, or an average of these current values. It is thus possible, for example, to obtain information on the radio link quality in real time.

According to another embodiment, the method implements, prior to allocating radio resources in accordance with an allocation scheme implementing a second radio quality of service configuration, receiving a notification from the client equipment, informing the base station that said at least one downlink current value is associated with a radio link quality level lower than said at least one first downlink value. The client equipment can therefore take one or more quality measurements of the radio downlink, at different times, to obtain one or more values of a quality of the radio downlink, and compare the downlink current value(s) with the first downlink value. If at least one current value has a radio quality level lower than the first value, a notification can be sent to the base station.

According to these various embodiments, the base station can thus know in “real time” the current value of a quality of the radio link for the client equipment (or any other equipment transmitting this information to the base station), or more simply receive a notification when the current value changes sufficiently to be taken into account.

According to a particular embodiment, the allocation of radio resources in accordance with an allocation scheme implementing a second radio quality of service configuration is implemented when several successive uplink or downlink current values are associated with a radio link quality level lower than said at least one first uplink or downlink value respectively.

Thus, in some embodiments, the base station may not change the allocation of resources for the client equipment, in order to switch from a first configuration to a second configuration, in the event of a one-off deterioration of the radio link. For example, a time range can be defined by the operator in the order of a few seconds, a few minutes or a few hours.

If more than half of the current values measured over this time range have a radio link quality level lower than the first value, the base station can change the resource allocation for at least one stream of the client equipment to switch from a first configuration to a second configuration.

Similarly, a notification as described above can only be sent to the base station if more than half of the current values measured over a defined time range have a radio link quality level lower than the first value.

According to a particular embodiment, the method further implements:
if at least one new current value of a quality of the radio uplink or downlink between said base station and said client equipment, obtained from at least one new measurement taken by said client equipment or said base station, is associated with a radio link quality level greater than or equal to at least one second value of a quality of a radio uplink or downlink between the base station and the client equipment respectively, allocating radio resources to said at least one equipment attached to said base station in accordance with an allocation scheme implementing said first radio quality of service configuration for at least one stream transmitted or received by said client equipment.

According to this embodiment, the base station can again change the allocation of radio resources to return to the first configuration for at least one stream of the client equipment, when the quality of the radio uplink and/or downlink, one or the other, is no longer deteriorated for example, or is less deteriorated.

For example, said at least one uplink or downlink first and/or second value or current value belongs to the group comprising:
a reference signal receive power (RSRP);
a channel quality indicator (CQI);
an indicator constructed from the CQI;
a channel state information (CSI);
an indicator constructed from the CSI, for example a CRI-RI-PMI-CQI indicator (where RI is a rank indicator and PMI is a precoding matrix indicator);
etc.

The RSRP is an average value of the receive power of the reference signal transmitted by the base station. This is a simple measurement, taken by the physical layer of the communication equipment, expressed in watts or in dBm. The value is typically comprised between −140 dBm (poor quality radio link) and −44 dBm (very good quality radio link).

The RSRP can therefore be used to measure a first and/or second value and/or current value of a quality of the radio downlink at a time or over a time range. The RSRP can also be used to estimate the quality of the radio uplink.

The CQI is an indicator of the radio link quality, determined by the communication equipment. It can be used by the base station, in particular by the scheduler, to determine the modulation to be used at a time t.

The CQI can therefore be used to measure a first and/or second value and/or current value of a quality of the radio downlink at a time or over a time range.

The CSI, or CRI-RI-PMI-CQI, can in particular be used to estimate the quality of the radio uplink.

Other indicators can also be used to obtain an uplink and/or downlink first and/or second and/or current value.

According to a particular embodiment, the second uplink and/or downlink value is equal to the first uplink and/or downlink value.

As a variant, the second uplink and/or downlink value is different from the first uplink and/or downlink value.

In particular, said allocation of radio resources in accordance with an allocation scheme implementing said first radio quality of service configuration for at least one stream transmitted or received by said client equipment is implemented if said at least one new current value of a quality of the radio uplink is greater than said at least one second uplink value and if said at least one new current value of a quality of the radio downlink is greater than said at least one second downlink value.

In other words, in some embodiments, the base station can again change the allocation of radio resources to return to the first configuration for at least one stream of the client equipment, when the quality of the radio uplink and downlink is no longer deteriorated, or is less deteriorated.

According to a particular embodiment, the allocation of radio resources in accordance with an allocation scheme implementing a second radio quality of service configuration implements said first radio quality of service configuration for at least one stream transmitted or received by an equipment attached to said base station, distinct from said client equipment.

In other words, in some embodiments, the switch from a first configuration to a second radio quality of service configuration only relates to the client equipment, for which the radio link quality is deteriorated. The configuration of the other item(s) of equipment attached to the base station can be done independently of the configuration change for the client equipment.

The allocation scheme can thus allocate radio resources according to the second quality of service configuration for the client equipment, and according to the first quality of service configuration for at least one other equipment attached to the base station.

According to a particular embodiment, said at least one first value of a quality of a radio uplink or downlink between the base station and the client equipment, and/or said at least one second value of a quality of a radio uplink or downlink between the base station and the client equipment, is obtained from:
at least one measurement taken by said client equipment;
at least one measurement taken by said base station;
a reading in a table, an abacus, etc.

Thus, according to a first example, the client equipment takes one or more measurements of a quality of the radio downlink, at different times, and reports this or these measurements to the base station, or an average of these measurements. The first/second downlink value can be obtained from this or these measurements, or from the average of these measurements.

According to a second example, the base station takes one or more measurements of a quality of the radio uplink, at different times. The first/second uplink value can be obtained from this measurement or from the average of these measurements.

In particular, the first/second uplink and/or downlink value can be determined when the equipment is stable, in the geographical (its position is substantially fixed) and/or radio (its transmission channel varies little) sense. For example, the equipment is a mobile terminal that remains within a radius of 25 metres of an initial position for a certain period of time (for example for at least 3 to 5 minutes). In this case, the terminal is equipped with geolocation means to determine that its position is substantially fixed.

According to a third example, the first/second uplink and/or downlink value is a theoretical value, obtained from tables such as tables, abacuses, etc.

According to a fourth example, the first/second uplink and/or downlink value corresponds to an acceptability threshold for the radio link quality defined by the operator.

In a particular embodiment, the method comprises, for example during the first phase, prior steps of obtaining at least one reference value of a quality of a radio uplink or downlink between the base station and the client equipment, and verifying that said at least one first uplink or downlink value is associated with a radio link quality level greater than or equal to said at least one uplink or downlink reference value respectively.

In this case, the first uplink, respectively downlink, value can for example be measured when the equipment is installed, and compared with an uplink, respectively downlink, reference value, obtained from a table, an abacus, etc.

These steps can be used to validate that the first uplink and/or downlink “practical” value is associated with a radio link quality level greater than or equal to the uplink and/or downlink “theoretical” reference value.

Another embodiment relates to a corresponding base station, configured to communicate with at least one communication equipment, said at least one communication equipment comprising a client equipment, comprising:
means for obtaining at least one first value of a quality of a radio uplink or downlink between said base station and said client equipment,
means for allocating radio resources to said at least one equipment attached to said base station in accordance with an allocation scheme implementing a first radio quality of service configuration dependent on said at least one first uplink or downlink value for at least one stream transmitted or received by said client equipment,
means for allocating radio resources to said at least one equipment attached to said base station in accordance with an allocation scheme implementing a second radio quality of service configuration for at least one stream transmitted or received by said client equipment, activated if at least one current value of a quality of the radio uplink or downlink between said base station and said client equipment, obtained from at least one measurement taken by said client equipment or said base station, is associated with a radio link quality level lower than said at least one first uplink or downlink value respectively, said second configuration having a lower radio quality of service level than said first configuration.

Such a base station is notably adapted to implement the method for communication previously described. It can be for example an eNodeB or gNode. Such a base station could, of course, comprise the different characteristics relating to the method according to the invention, which may be combined or taken separately. Thus, the characteristics and advantages of the base station are the same as those of the method previously described. Therefore, they are not detailed further.

The invention also relates to a method for managing communication between a base station and at least one communication equipment attached to the base station, said at least one communication equipment comprising a client equipment, comprising, implemented by said client equipment:
obtaining at least one first value of a quality of a radio downlink between the base station and the client equipment,
if said at least one first downlink value is measured by the client equipment, transmitting said at least one first downlink value to the base station, intended to be used by the base station for allocating radio resources to said at least one equipment attached to the base station in accordance with an allocation scheme implementing a first radio quality of service configuration dependent on said at least one first downlink value for at least one stream transmitted or received by the client equipment,
measuring at least one current value of a quality of the radio downlink between the base station and the client equipment,
transmitting said at least one downlink current value to the base station, or a notification informing the base station that said at least one downlink current value is associated with a radio link quality level lower than said at least one first downlink value, said at least one downlink current value or said notification being intended to be used by the base station for allocating radio resources to said at least one equipment attached to the base station in accordance with an allocation scheme implementing a second radio quality of service configuration for at least one stream transmitted or received by the client equipment, said second configuration having a lower radio quality of service level than said first configuration.

According to the invention, the client equipment can thus inform the base station in real time, if the quality of the radio link between the base station and the client equipment deteriorates. Part of the processing (monitoring) is thus moved from the base station to the client equipment. In this way, the base station can change the allocation scheme to allocate radio resources in accordance with a second radio QoS configuration for at least one stream transmitted or received by the client equipment (for example, allocation with relative prioritisation or “best effort” allocation).

It should be noted that if said at least one first downlink value is previously known to the base station (for example obtained from a table, such as a reference table), there is no need to transmit it from the client equipment to the base station.

In particular, the client equipment can implement a step of determining its geographical position. Its geographical position can notably be determined for each measurement of at least one current value. An item of information representative of this position can be reported to the base station.

It is thus possible to determine whether the position of the client equipment is substantially fixed.

The invention also relates to a corresponding client equipment, configured to communicate with a base station, comprising:
means for obtaining at least one first value of a quality of a radio downlink between said base station and said client equipment,
means for transmitting said at least one first downlink value to said base station, intended to be used by said base station for allocating radio resources to at least one equipment attached to said base station in accordance with an allocation scheme implementing a first radio quality of service configuration dependent on said at least one first downlink value for at least one stream transmitted or received by said client equipment, activated if said at least one first value is measured by the client equipment, said at least one equipment attached to said base station comprising said client equipment,
means for measuring at least one current value of a quality of the radio downlink between said base station and said client equipment,
means for transmitting said at least one downlink current value to said base station, or a notification informing said base station that said at least one downlink current value is associated with a radio link quality level lower than said at least one first downlink value, said at least one downlink current value or said notification being intended to be used by said base station for allocating radio resources to said at least one equipment attached to said base station in accordance with an allocation scheme implementing a second radio quality of service configuration for at least one stream transmitted or received by said client equipment, said second configuration having a lower radio quality of service level than said first configuration.

Such an equipment is notably adapted to implement the method for managing communication previously described. For example, such an equipment is a mobile equipment of the network (mobile phone, smartphone, laptop, etc., particularly capable of communicating on an LTE or NG network) or a fixed intermediate equipment installed at a client's site (private individual, company, etc.) and that is connected to the infrastructure of an operator/service provider (CPE).

According to a particular embodiment, such an equipment is equipped with geolocation means, for example a GPS.

The client equipment could, of course, comprise the different characteristics relating to the method according to the invention, which may be combined or taken separately. Thus, the characteristics and advantages of the client equipment are the same as those of the method previously described. Therefore, they are not detailed further.

The invention further relates to one or more computer programs comprising instructions for implementing a method for communication or a method for managing communication as described above when this or these programs are executed by at least one processor. The invention moreover relates to one or more computer-readable storage media on which are saved one or more computer programs comprising program code instructions for implementing at least one step of a method for communicating or of a method for managing communication as described above according to any one of the embodiments. Such storage media can be any entity or device able to store a program.

### BRIEF DESCRIPTION OF THE DRAWINGS

Other characteristics and advantages of the invention will emerge more clearly upon reading the following description of a particular embodiment, provided as a simple illustrative non-restrictive example, and the annexed drawings, wherein:

FIG. 1 shows the main steps implemented according to a particular embodiment of the invention;

FIG. 2 shows the conventional allocation of radio resources in a context of controlled overall congestion;

FIG. 3A illustrates the conventional allocation of radio resources in a context of uncontrolled overall congestion;

FIG. 3B illustrates the allocation of radio resources in a context of uncontrolled overall congestion according to one embodiment of the invention;

FIG. 4A illustrates the conventional allocation of radio resources in a context of uncontrolled GBR congestion;

FIG. 4B illustrates the allocation of radio resources in a context of uncontrolled GBR congestion according to one embodiment of the invention;

FIG. 5 shows an example of use of the CQI radio quality indicator according to one embodiment of the invention;

FIG. 6 shows the simplified structure of a base station according to a particular embodiment;

FIG. 7 shows the simplified structure of a client equipment according to a particular embodiment.

### DETAILED DESCRIPTION OF CERTAIN ILLUSTRATIVE EMBODIMENTS

### General Principle

The context is that of a communication network implementing a base station (for example, eNodeB, gNode, etc.) and at least one communication equipment (for example, a terminal, a CPE, etc.) located in the cell served by the base station, said at least one communication equipment comprising a client equipment.

The general principle of the invention is based on changing the radio quality of service configuration applied to at least one stream of a communication equipment, to switch from a first configuration to a second configuration having a lower radio quality of service level, when the quality of the radio link between the base station and the communication equipment deteriorates.

For example, the first configuration can be associated with an allocation with strict prioritisation with a first guaranteed bit rate (for example previously negotiated with the operator) and the second configuration can be associated with an allocation with strict prioritisation with a second guaranteed bit rate, lower than the first guaranteed bit rate.

According to another example, the first configuration can be associated with an allocation with strict prioritisation with a guaranteed bit rate and the second configuration can be associated with an allocation with relative prioritisation.

According to yet another example, the first configuration can be associated with strict prioritisation allocation with a guaranteed bit rate and the second configuration can be associated with a “best effort” allocation.

According to a last example, the first configuration can be associated with an allocation with relative prioritisation and the second configuration can be associated with a “best effort” allocation. The proposed solution can thus, in at least some embodiments, help to improve the quality of service for the item(s) of equipment located in the cell served by the base station compared to at least some solutions of the prior art, in particular in the two cases of uncontrolled congestion presented in relation to the prior art.

In particular, the invention proposes a new solution for allocating radio resources to the equipment attached to the base station, making it possible, according to a particular embodiment, to optimise the quality of service for all the equipment located in the cell served by the base station.

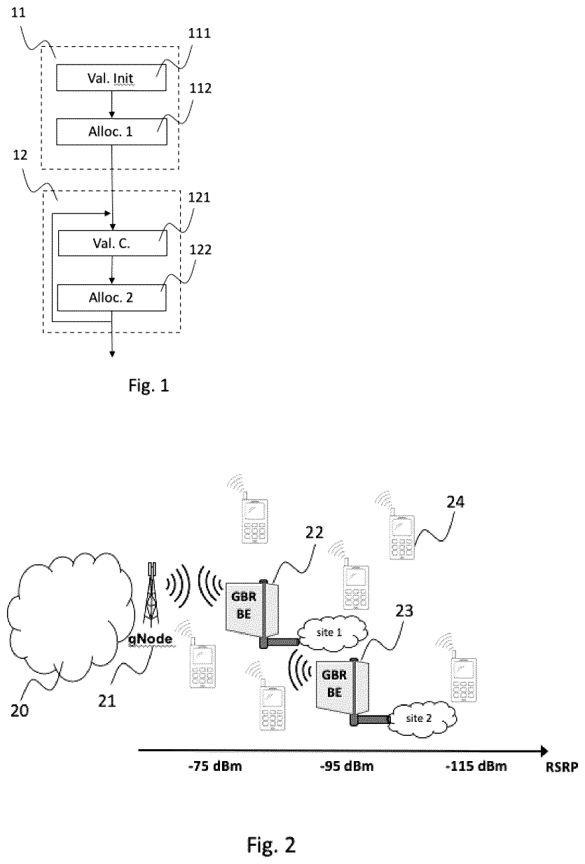

In relation to FIG. 1, the main steps implemented by the base station according to some embodiments of the invention are presented below.

During a first phase 11, referred to as the initialisation phase, a first value of a quality of a radio uplink between the base station and the client equipment attached to the base station and/or a first value of a quality of the radio downlink between the base station and the client equipment can be obtained (111). Such first uplink and/or downlink values can be obtained from at least one measurement of a quality of the radio link taken by the client equipment, at least one measurement of a quality of the radio link taken by the base station, a reading in a table, etc.

The base station (or “scheduler”) can allocate (112) radio resources to the client equipment and, where applicable, to at least one other equipment attached to the base station, in accordance with an allocation scheme implementing, for example, for at least one stream transmitted or received by the client equipment, a first radio quality of service configuration dependent on the first uplink and/or downlink value(s) (for example using a dedicated GBR “bearer”).

For example, if the first value of a quality of a radio link is in the order of −70 dBm, which means that the radio link is of good quality, the first radio quality of service configuration can be associated with an allocation with strict prioritisation at a guaranteed bit rate, with a high guaranteed bit rate, for example in the order of a few dozen megabits per second. If the first value of a quality of a radio link is in the order of −95 dBm, which means that the radio link is of average quality, the first radio quality of service configuration can be associated with an allocation with strict prioritisation at a guaranteed rate with an average bit rate, for example in the order of a few megabits per second, or with an allocation with relative prioritisation.

During a second phase 12, referred to as the operating phase, several values of a quality of a radio uplink and/or downlink, referred to as the uplink and/or downlink current values, can be measured at different times. The uplink current values can be obtained from at least one measurement of a quality of the radio link taken by the base station (121), and the downlink current values can be obtained from at least one measurement of a quality of the radio link taken by the client equipment. Possibly, the client equipment can transmit the current measurements/values to the base station.

Possibly, an average downlink and/or uplink current value can be determined for a given time range, by the base station and/or by the client equipment.

The downlink and/or uplink current value(s) (possibly averaged) can be compared with the first downlink and/or uplink value respectively. This comparison can be performed by the base station or by the client equipment, according to the information available to the base station or the client equipment. If the comparison is performed by the client equipment, the client equipment can send a notification to the base station to inform it of the result of the comparison (downlink and/or uplink current value associated with a quality level lower than the first downlink and/or uplink value, or significant change in the downlink and/or uplink current value, etc.).

If the quality of the radio link between the base station and the client equipment deteriorates, i.e. if:
a downlink and/or uplink current value,
or a downlink and/or uplink average current value over a given time range, or
at least one downlink and/or uplink current value over a given time range,

is associated with a quality level lower than the first downlink and/or uplink value respectively, the base station (or the “scheduler”) can allocate (122) radio resources to the client equipment and, where applicable, to at least one other equipment attached to the base station, in accordance with an allocation scheme implementing, for at least one stream transmitted or received by the client equipment, a second radio quality of service configuration having a radio quality of service level lower than the first configuration (for example using a dedicated non-GBR “bearer”).

According to a particular embodiment, it is also possible to keep the first radio quality of service configuration for at least one stream transmitted or received by the client equipment if the quality of the radio link between the base station and the client equipment remains stable, or to return to the first radio quality of service configuration for at least one stream transmitted or received by the client equipment if the quality of the radio link between the base station and the client equipment improves, i.e. if:
a new downlink and/or uplink current value, or
a new downlink and/or uplink average current value over a given time range, or
at least one new downlink and/or uplink current value over a given time range, is associated with a radio link quality level greater than or equal to a second value of a quality of a radio downlink and/or uplink between the base station and the client equipment, respectively.

The operating phase may implement at least one iteration of the steps described above. Thus, new measurements of the quality of the radio uplink and/or downlink between the base station and the client equipment can be taken regularly, for example every second, every 30 seconds, every minute, or when a change in the channel is detected. Information on the radio link quality is thus available in “real time”. The allocation of radio resources for the various equipment attached to the base station can be updated to take into account the changes in the quality of the radio uplink and/or downlink between the base station and the client equipment.

### EMBODIMENT

An embodiment of the invention is described below, in a network comprising a base station and a plurality of communication equipment.

The use of the quality of the radio downlink between the base station and at least one communication equipment, referred to as client equipment, to optimise the allocation of resources is described below. Of course, this is just an example, and the quality of the radio uplink can also be used, alone or in combination with the quality of the radio downlink, to optimise the allocation of resources.

According to the example illustrated in FIG. 2, a base station 21, a first communication equipment installed at a first customer site, for example a business or home CPE1 22 allowing FWA (Fixed Wireless Access) access, a second communication equipment installed at a second customer site, for example a business or home CPE2 23 also allowing FWA access, and a plurality of terminals 24 are considered. The base station communicates with the network core 20.

When the CPE1 22 is installed, the CPE1 22 can measure a first value of a quality of a radio downlink between the base station and the CPE1 22, for example by measuring the reference signal receive power.

This first value, noted RSRP1, can in particular be transmitted to the base station, or to the operator, to check that it is associated with a quality level greater than or equal to a value (a reference value, for example) known to the base station, or to the operator. For example, such a value is defined from tables such as reference tables or abacus.

As a variant, an acceptability threshold for the radio link quality can be defined, and the base station, or the operator, can check that the first value is indeed associated with a quality level greater than or equal to the acceptability threshold. Such an acceptability threshold can in particular be defined based on a compromise between the estimated load in the cell and the desired guaranteed bit rate.

Thus, according to at least one embodiment, the operator can determine in advance a guaranteed bit rate, a number of users and/or GBR streams per cell, and an acceptability threshold for the radio link quality (at which a user or a stream can obtain a guaranteed bit rate GBR).

According to the example illustrated in FIG. 2, this value RSRP1 is, for example, in the order of −80 dBm.

The base station/operator then indicates whether the access of the first customer site is eligible, and whether the desired guaranteed bit rates are authorised. Otherwise, the operator may offer lower guaranteed bit rates or non-guaranteed bit rates.

It is assumed hereafter that the desired guaranteed bit rates are authorised. The base station can therefore allocate resources to the various equipment of its cell. It can in particular implement a radio quality of service configuration associated with an allocation with GBR prioritisation for at least one stream entering or leaving the CPE1 22 of the first customer site, and a “best effort” allocation for at least one other stream entering or leaving the CPE1 22 of the first customer site.

Similarly, the base station can implement a radio quality of service configuration associated with an allocation with GBR prioritisation for at least one stream entering or leaving the CPE2 23 of the second customer site, and a “best effort” allocation for at least one other stream entering or leaving the CPE2 23 of the second customer site.

The cell is therefore in a no congestion or in a controlled overall congestion situation.

The CPE1 22 measures at different times the quality of its radio link with the base station 21, for example by measuring the reference signal receive power.

If the current value RSRPc is associated with a radio quality level lower than the first value RSRP1, there is an overconsumption of radio resources and fewer resources are available (for example, fewer “resource blocks” RB) for the other equipment in the cell.

If the current value RSRPc is associated with a radio quality level greater than or equal to the first value RSRP1, there is an underconsumption of radio resources and more resources are available (for example, more “resource blocks” RB) for the other equipment in the cell.

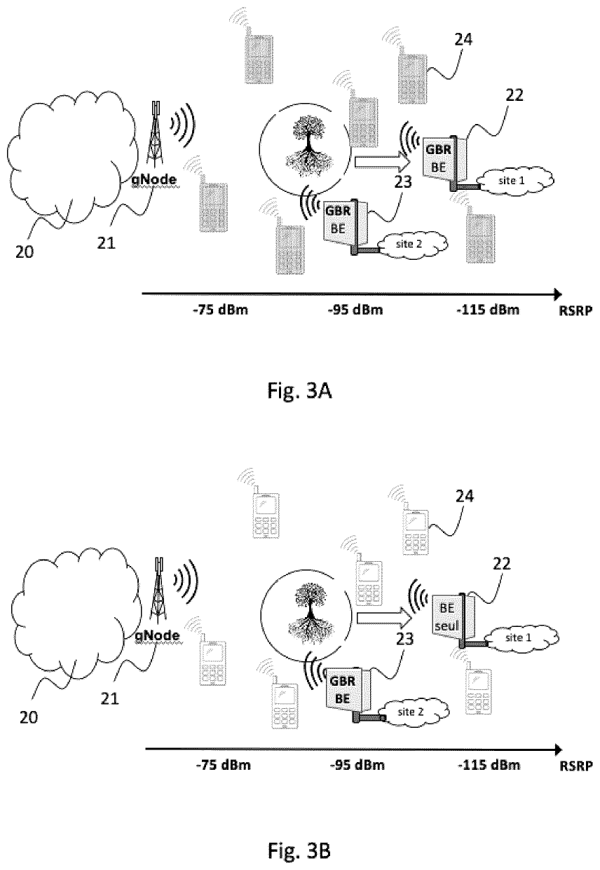

According to a first example illustrated in FIGS. 3A and 3B, it is considered that at least one current value RSRPc measured by the CPE1 22 of the first customer site decreases (for example from −80 dBm to −105 dBm), for example due to the presence of an obstacle on the transmission channel.

The cell therefore shifts to an uncontrolled overall congestion situation.

In the example illustrated in FIG. 3A, without the implementation of the invention, the base station 21 allocates resources to the various equipment (CPE1 22, CPE2 23, terminals 24) and seeks to provide a guaranteed target bit rate to the streams of the equipment benefiting from a GBR configuration (CPE1 22 and CPE2 23) as a priority. The remaining radio resources are then assigned to the other equipment (terminals 24) and to the BE streams of the CPE1 22 and CPE2 23.

There is an overconsumption of radio resources to provide the CPE1 22 with the desired guaranteed bit rate. As the base station seeks to allocate resources to the GBR streams of the CPE1 22 and CPE2 23 as a priority, there are few radio resources left to allocate to the BE streams of the CPE1 22, CPE2 23 and terminals 24. Each BE stream is therefore negatively impacted.

In the example illustrated in FIG. 3B, with the implementation of the invention, if the current value RSRPc is associated with a quality level of the downlink radio lower than the first value RSRP1, the base station 21 can change the radio quality of service configuration for the GBR streams of the CPE1 22 of the first customer site. For example, the base station 21 can change the processing configuration of the GBR streams of the CPE1 22 (first configuration) to BE (second configuration). The initially GBR streams transmitted or received by the CPE1 22 of the first site therefore switch to BE QoS. An alarm can possibly be generated to inform an equipment upstream of the base station 21, the operator or the customer, for example using the SCEF (“Service Capability Exposure Function”) API (“Application Programming Interface”) in 4G, or the NEF API (“Network Exposure Function”) in 5G. The customer can use these APIs to be notified of an event for a given equipment. For example, it is possible to define and implement a notification such as “QoS deteriorated from GBR to BE due to a drop in radio quality”.

The base station 21 seeks to allocate resources to the GBR streams of the CPE2 23 as a priority. The GBR streams of the CPE2 23 of the second customer site are therefore served according to the initial configuration without any problems. All the BE streams share the remaining radio resources. According to this embodiment, there are sufficient radio resources left to be allocated to the BE streams of the CPE1 22, CPE2 23 and terminals 24. So, if the number of BE streams before “downgrading” the GBR streams transmitted or received by the CPE 22 of the first site to BE streams is noted n, and the volume of radio resources available after assignment to the GBR streams is noted X, then the radio resources for each BE stream change from X/n (controlled overall congestion) to X/(n+1), in the case of a “Round Robin” scheduling algorithm. It should be noted that the higher the number of BE streams, the more negligible the impact. In all cases, each BE stream is better served according to the invention.

If the deterioration is temporary, and a new current value RSRPc measured by the CPE 22 of the first site is associated with a radio quality level greater than or equal to a second value RSRP2, for example equal to the first value RSRP1, a return to normal is possible.

In other words, if afterwards a current value RSRPc is associated with a quality level of the radio downlink greater than or equal to the second value RSRP2, the base station 21 can change again the radio quality of service configuration for the GBR streams of the CPE1 22 previously downgraded to BE streams. For example, the base station 21 changes the processing configuration of these BE streams of the CPE1 22 (first configuration) to GBR (second configuration). In other words, the GBR QoS configurations are reinstalled.

An alarm can possibly be generated to inform an equipment upstream of the base station 21, the operator or the customer, for example using a SCEF or NEF coupling as previously mentioned. In this case, it is possible to define and implement a notification such as “QoS improved from BE to GBR due to a rise in radio quality”.

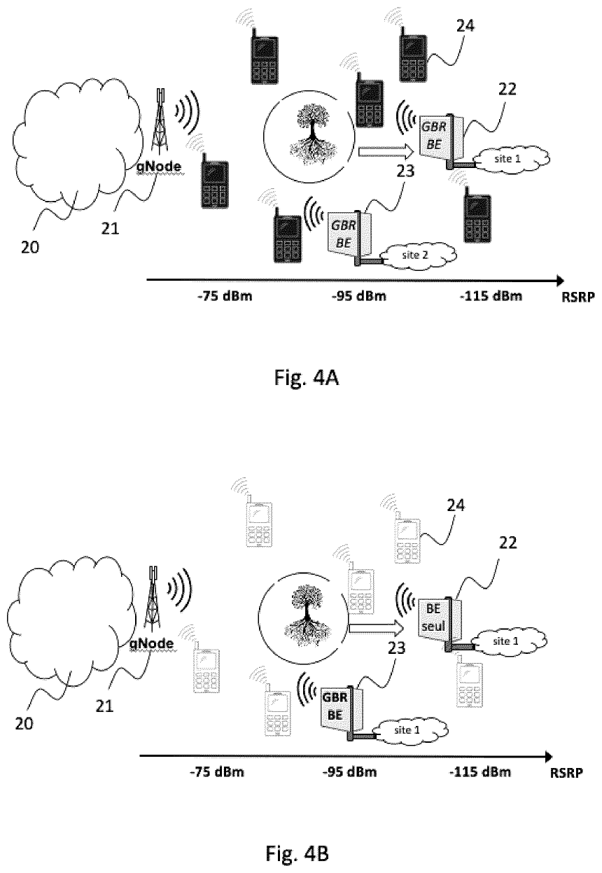

According to a second example illustrated in FIGS. 4A and 4B, it is considered that at least one current value RSRPc measured by the CPE1 22 of the first customer site decreases significantly (for example from −80 dBm to −120 dBm), for example due to the presence of an obstacle on the transmission channel.

The cell therefore shifts to an uncontrolled GBR congestion situation.

In the example illustrated in FIG. 4A, without the implementation of the invention, the base station 21 allocates resources to the various equipment (CPE1 22, CPE2 23, terminals 24) and seeks to provide a guaranteed target bit rate to the streams of the equipment benefiting from a GBR configuration (CPE1 22 and CPE2 23) as a priority.

There is an overconsumption of radio resources in an attempt to provide the CPE1 22 with the desired guaranteed bit rate. In particular, according to this example, the CPE1 22 of the first site overconsumes radio resources compared to the initial setting, to such an extent that the theoretical volume of radio resources required for the GBR streams exceeds the capacities of the cell.

All or some of the GBR streams of the CPE1 22 and CPE2 23 (depending on the protection mechanisms activated) are negatively deteriorated, the minimum guaranteed bit rates are not reached.

In addition, all of the BE streams are negatively impacted.

In the example illustrated in FIG. 4B, with the implementation of the invention, if the current value RSRPc is associated with a quality level of the downlink radio lower than the first value RSRP1, the base station 21 changes the radio quality of service configuration for the GBR streams of the CPE1 22 of the first customer site. For example, the base station 21 changes the processing configuration of the GBR streams of the CPE1 22 (first configuration) to BE (second configuration). The initially GBR streams transmitted or received by the CPE1 22 of the first site therefore switch to BE QoS. An alarm can possibly be generated to inform an equipment upstream of the base station 21, the operator or the customer, for example using an SCEF or NEF coupling as previously mentioned, for example with a notification such as “QoS deteriorated from GBR to BE due to a drop in radio quality”.

The base station 21 seeks to allocate resources to the GBR streams of the CPE2 23 as a priority. The GBR streams of the CPE2 23 of the second customer site are therefore served according to the initial configuration without any problems. All the BE streams share the remaining radio resources. According to this embodiment, there are therefore sufficient radio resources left to be allocated to the BE streams of the CPE1 22, CPE2 23 and terminals 24. So, if the number of BE streams before “downgrading” the GBR streams transmitted or received by the CPE 22 of the first site to BE streams is noted n, and the volume of radio resources available after assignment to the GBR streams is noted X, then the radio resources for each BE stream change from X/n (controlled overall congestion) to X/(n+1), in the case of a “Round Robin” scheduling algorithm. It should be noted that the higher the number of BE streams, the more negligible the impact. In all cases, the BE streams are preserved.

If the deterioration is temporary, and a new current value RSRPc measured by the CPE 22 of the first site is associated with a radio quality level greater than or equal to a second value RSRP2, for example equal to the first value RSRP1, a return to normal is possible.

In other words, if afterwards a current value RSRPc is associated with a quality level of the radio downlink greater than or equal to the second value RSRP2, the base station 21 can change again the radio quality of service configuration for the GBR streams of the CPE1 22 previously downgraded to BE streams. For example, the base station 21 changes the processing configuration of these BE streams of the CPE1 22 (first configuration) to GBR (second configuration). In other words, the GBR QoS configurations are reinstalled.

An alarm can possibly be generated to inform an equipment upstream of the base station 21, the operator or the customer, for example using a SCEF or NEF coupling as previously mentioned, for example with a notification such as “QoS improved from BE to GBR due to a rise in radio quality”.

Thus, according to the examples presented above, the proposed solution can help to provide the guaranteed QoS over 4G or 5G to a customer for the connectivity of one of their customer sites, if the available resources allow it. The negotiated QoS parameters can be retained as long as the quality of the radio link between the customer site antenna (CPE1 22 of the first customer site) and the base station is greater than or equal to the first value, and therefore “acceptable” to the operator.

As previously indicated, in some embodiments, an acceptability threshold for the radio link quality can be defined, and the base station, or the operator, checks that the first value is associated with a quality level greater than or equal to the acceptability threshold.

The notion of “acceptability” of the radio link can, for example, depend on a compromise between the load in the cell, the guaranteed bit rate and the radio link quality. If the radio link quality deteriorates excessively (outside the acceptability window defined by the operator), for example, construction of a wall, moving the antenna on the customer site, tree, etc., the QoS parameters can be renegotiated and revised downwards. The customer and the operator can be alerted, and can thus make decisions and take actions as appropriate.

For example, “long-term” actions can be set up between the operator and the client if the radio link quality remains deteriorated for a long period (for example for more than 24 hours):
reducing the previously negotiated guaranteed bit rate;
cancelling the guaranteed bit rate and negotiating a relative priority;
cancelling the guaranteed bit rate, the negotiated QoS of the stream becomes BE;
cancelling the relative priority, the negotiated QoS of the stream becomes BE;
etc.

### Variants

An embodiment according to which the values of a quality of a radio link are values of the power received by the client equipment (RSRP) has been described above.

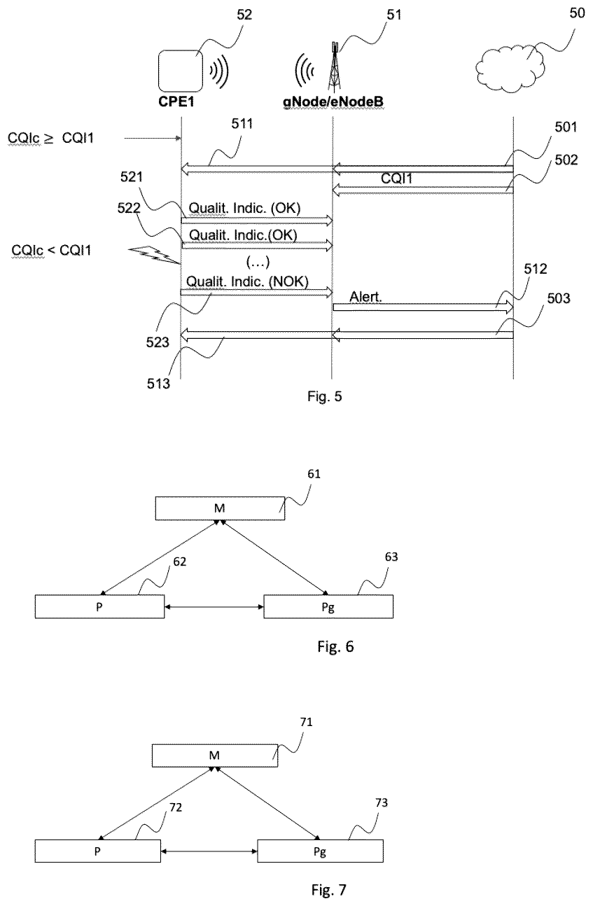

As a variant, the values of a quality of a radio link can be a quality indicator of the CQI channel. Thus, according to the example illustrated in FIG. 5, the base station 51 can receive, from the network core 50, the command to create a dedicated “bearer” for a first configuration (501), for example a GBR configuration for a type of stream, as well as a first value of the radio link between the base station 51 and the CPE1 52 (502), corresponding to the initial CQI, noted CQI1. The base station 51 can allocate resources to the CPE1 52 using the dedicated bearer for the GBR configuration (511).

The CPE1 52 can take one or more measurements of the quality of the radio downlink, and send the current CQI, noted CQIc, to the base station 51 (521, 522, 523).

As long as the current CQI has a radio quality level greater than or equal to the initial CQI (521, 522) (CQIc>CQI1), the dedicated bearer for the BGR configuration of CPE1 52 is not changed.

However, if the current CQI has a radio quality level lower than the initial CQI (521, 522), the base station 51 can send an alert (512) to the network core 50. The base station 51 can receive the command of a dedicated bearer for a second configuration (503), for example a GBR configuration with a lower guaranteed bit rate than the first configuration.

The base station 51 can allocate resources to the CPE1 52 using the new bearer (513). In addition, examples have been described above according to which the client equipment is a fixed equipment, enabling for example FWA access. In other embodiments, the client equipment can be a mobile terminal.

In this case, the method described previously can be implemented when the terminal stabilises in the cell (in the radio and/or geographical sense), in particular to obtain the first value if it is determined from a measurement of the radio link quality. The connectivity of a moving terminal (i.e. its bit rate) could therefore switch from GBR to non-GBR, then GBR, etc., depending on the characteristics of the cells it passes through and its position in the cell.

### Simplified Structures of a Base Station and a Client Equipment

In relation to FIG. 6, the simplified structure of a base station according to at least one embodiment described above is now presented.

As illustrated in FIG. 6, such a base station comprises at least one memory 61 comprising a buffer memory, at least one processing unit 62, equipped for example with a programmable computing machine or a dedicated computing machine, for example a processor P, and controlled by the computer program 63, implementing steps of the method for communicating according to at least one embodiment of the invention.

At initialisation, the code instructions of the computer program 63 are for example loaded into a RAM memory before being executed by the processor of the processing unit 62.

The processor of the processing unit 62 implements steps of the method for communicating previously described, according to the instructions of the computer program 63, to:
obtain at least one first value of a quality of a radio uplink or downlink between the base station and the client equipment,
allocate radio resources to the client equipment, and possibly to at least one other equipment attached to the base station, in accordance with an allocation scheme implementing a first radio quality of service configuration dependent on said at least one first uplink or downlink value for at least one stream transmitted or received by the client equipment,
allocate radio resources to the client equipment, and possibly to at least one other equipment attached to the base station, in accordance with an allocation scheme implementing a second radio quality of service configuration for at least one stream transmitted or received by the client equipment, activated if at least one current value of a quality of the radio uplink or downlink between the base station and the client equipment, obtained from at least one measurement taken by the client equipment or the base station, is associated with a radio link quality level lower than said at least one first uplink or downlink value respectively.

Finally, a description is given, in relation to FIG. 7, of the simplified structure of a client equipment according to at least one embodiment described above.

As illustrated in FIG. 7, such a client equipment comprises at least one memory 71 comprising a buffer memory, at least one processing unit 72, equipped for example with a programmable computing machine or a dedicated computing machine, for example a processor P, and controlled by the computer program 73, implementing steps of the method for managing communication according to at least one embodiment of the invention.

At initialisation, the code instructions of the computer program 73 are for example loaded into a RAM memory before being executed by the processor of the processing unit 72.

The processor of the processing unit 72 implements steps of the method for managing communication previously described, according to the instructions of the computer program 73, to:
obtain at least one first value of a quality of a radio downlink between the base station and the client equipment,
transmit said at least one first downlink value to the base station, said at least one first value being intended to be used by the base station for allocating radio resources to the client equipment, and possibly to at least one other equipment attached to the base station, in accordance with an allocation scheme implementing a first radio quality of service configuration dependent on said at least one first downlink value for at least one stream transmitted or received by the client equipment, activated if said at least one first value is measured by the client equipment,
measure at least one current value of a quality of the radio downlink between the base station and the client equipment,
transmit said at least one current downlink value to the base station, or a notification informing the base station that said at least one current downlink value is associated with a radio link quality level lower than said at least one first downlink value, said at least one current downlink value or said notification being intended to be used by the base station for allocating radio resources to the client equipment, and possibly to at least one other equipment attached to the base station, in accordance with an allocation scheme implementing a second radio quality of service configuration for at least one stream transmitted or received by the client equipment.

1. A method of communicating between a base station and at least one communication equipment attached to said base station, said at least one communication equipment comprising a client equipment, wherein the method comprises:
obtaining at least one first value of a quality of a radio uplink or downlink between said base station and said client equipment,
allocating radio resources to said at least one equipment attached to said base station in accordance with an allocation scheme implementing a first radio quality of service configuration dependent on said at least one first uplink or downlink value for at least one stream transmitted or received by said client equipment,
if at least one current value of a quality of the radio uplink or downlink between said base station and said client equipment, obtained from at least one measurement taken by said client equipment or said base station, is associated with a radio link quality level lower than said at least one first uplink or downlink value respectively, allocating (122) radio resources to said at least one equipment attached to said base station in accordance with an allocation scheme implementing a second radio quality of service configuration for at least one stream transmitted or received by said client equipment, said second configuration having a radio quality of service level lower than said first configuration.

2. The method according to claim 1, wherein the first and second radio quality of service configurations belong to a group comprising:
a configuration associated with a conventional “best effort” allocation of radio resources;
a configuration associated with an allocation of radio resources with relative prioritisation prioritization; and
a configuration associated with an allocation of radio resources with strict prioritisation prioritization at a guaranteed bit rate.

3. The method according to claim 1, wherein the method implements, prior to allocating radio resources in accordance with an allocation scheme implementing a second radio quality of service configuration, receiving said at least one downlink current value, from said client equipment.

4. The method according to claim 1, wherein the method implements, prior to allocating radio resources in accordance with an allocation scheme implementing a second radio quality of service configuration, receiving a notification from said client equipment, informing said base station that said at least one downlink current value is associated with a radio link quality level lower than said at least one first downlink value.

5. The method according to claim 1, wherein the allocation of radio resources in accordance with an allocation scheme implementing a second radio quality of service configuration is implemented when several successive uplink or downlink current values are associated with a radio link quality level lower than said at least one first uplink or downlink value respectively.

6. The method according to claim 1, wherein the method further implements:
if at least one new current value of a quality of the radio uplink or downlink between said base station and said client equipment, obtained from at least one new measurement taken by said client equipment or said base station, is associated with a radio link quality level greater than or equal to at least one second value of a quality of a radio uplink or downlink between the base station and the client equipment respectively, allocating radio resources to said at least one equipment attached to said base station in accordance with an allocation scheme implementing said first radio quality of service configuration for at least one stream transmitted or received by said client equipment.

7. The method according to claim 6, wherein the allocation of radio resources in accordance with an allocation scheme implementing said first radio quality of service configuration for at least one stream transmitted or received by said client equipment is implemented if said at least one new current value of a quality of the radio uplink is greater than said at least one second uplink value and if said at least one new current value of a quality of the radio downlink is greater than said at least one second downlink value.

8. The method according to claim 1, wherein the allocation of radio resources in accordance with an allocation scheme implementing a second radio quality of service configuration for at least one stream transmitted or received by said client equipment implements said first radio quality of service configuration for at least one stream transmitted or received by an equipment of said at least one equipment attached to said base station, distinct from said client equipment.

9. The method according to claim 1, wherein the at least one first value of a quality of a radio uplink or downlink between said base station and said client equipment is obtained from:
at least one measurement taken by said client equipment;
at least one measurement taken by said base station;
a reading in a table.

10. A method of managing communication between a base station and a client equipment,
wherein the method comprises, implemented by said client equipment:
obtaining at least one first value of a quality of a radio downlink between said base station and said client equipment, said first downlink value corresponding to
allocating radio resources to at least one communication equipment attached to said base station, said at least one communication equipment comprising the client equipment, in accordance with an allocation scheme implementing a first radio quality of service configuration dependent on said at least one first uplink or downlink value for at least one stream transmitted or received by said client equipment,
measuring at least one current value of a quality of the radio downlink between said base station and said client equipment,
transmitting said at least one downlink current value to said base station, or a notification informing said base station that said at least one downlink current value is associated with a radio link quality level lower than said at least one first downlink value, and
transmitting and/or receiving at least one stream by said client equipment, according to a second radio quality of service configuration implemented in accordance with a scheme for allocating resources to said communication equipment attached to said base station, said second radio quality of service configuration having a lower radio service quality of service level than said first configuration.

11. A base station configured to communicate with at least one communication equipment, said at least one communication equipment comprising a client equipment, wherein said base station comprises:
at least one processor; and
at least one non-transitory computer readable medium comprising instructions stored thereon which, when executed by the at least one processor, implement the method of claim 1.

12. A client equipment configured to communicate with a base station, comprising:
at least one processor; and
at least one non-transitory computer readable medium comprising program code instructions stored thereon which when executed by the at least one processor implement:
obtaining at least one first value of a quality of a radio downlink between said base station and said client equipment, said first downlink value corresponding to
allocating radio resources to at least one communication equipment attached to said base station, said at least one communication equipment comprising the client equipment, in accordance with an allocation scheme implementing a first radio quality of service configuration dependent on said at least one first uplink or downlink value for at least one stream transmitted or received by said client equipment,
measuring at least one current value of a quality of the radio downlink between said base station and said client equipment,
transmitting said at least one downlink current value to said base station, or a notification informing said base station that said at least one downlink current value is associated with a radio link quality level lower than said at least one first downlink value,
transmitting and/or receiving at least one stream by said client equipment, according to a second radio quality of service configuration implemented in accordance with a scheme for allocating resources to said communication equipment attached to said base station, said second radio quality of service configuration having a lower radio service quality of service level than said first configuration.

13. A non-transitory computer readable medium comprising code instructions of a computer program stored thereon for implementing, the method according to claim 1, when executed by a processor of the at least one device.

14. A non-transitory computer readable storage medium comprising program code instructions of a computer program stored thereon for implementing the method according to claim 10, when executed by a processor of the at least one device.

15. The method for managing communication according to claim 10, wherein the method comprises
when said at least one first value is measured by the client equipment, transmitting said at least one first downlink value to said base station.

16. The base station according to claim 11, wherein said first and second radio quality of service configurations belong to a group comprising:
a configuration associated with a conventional “best effort” allocation of radio resources;
a configuration associated with an allocation of radio resources with relative prioritization;
a configuration associated with an allocation of radio resources with strict prioritization at a guaranteed bit rate.

17. The base station according to claim 11, wherein the instructions further configure the at least one processor to:
receive said at least one downlink current value, from said client equipment, prior to allocating radio resources in accordance with an allocation scheme implementing a second radio quality of service configuration.

18. The base station according to claim 11, wherein the instructions further configure the at least one processor to:
receive a notification from said client equipment, informing said base station that said at least one downlink current value is associated with a radio link quality level lower than said at least one first downlink value, prior to allocating radio resources in accordance with an allocation scheme implementing a second radio quality of service configuration.

19. The base station according to claim 11, wherein the allocation of radio resources in accordance with an allocation scheme implementing a second radio quality of service configuration is implemented when several successive uplink or downlink current values are associated with a radio link quality level lower than said at least one first uplink or downlink value respectively.

20. The client equipment according to claim 12, wherein the instructions further configure the at least one processor to:
transmit said at least one first downlink value to said base station, when said at least one first value is measured by the client equipment.
